(19) United States
(12) Patent Application Publication
(10) Pub. No.: US 2013/0326408 A1
(43) Pub. Date: Dec. 5, 2013

(54) ELECTRONIC APPARATUS, CONTROL METHOD OF AN ELECTRONIC APPARATUS, AND CONTROL PROGRAM OF AN ELECTRONIC APPARATUS

(71) Applicant: KABUSHIKI KAISHA TOSHIBA, Tokyo (JP)

(72) Inventor: Hideki TSUTSUI, Tachikawa-shi (JP)

(73) Assignee: KABUSHIKI KAISHA TOSHIBA, Tokyo (JP)

(21) Appl. No.: 13/779,431

(22) Filed: Feb. 27, 2013

(30) Foreign Application Priority Data
May 31, 2012 (JP) 2012-125470

(51) Int. Cl. G06F 3/0482

(52) U.S. Cl. CPC G06F 3/0482
USPC 715/810

(57) ABSTRACT

One embodiment provides an electronic apparatus including: an output module configured to detect a first text from texts displayed on a display according to an operation by a user, and to output a menu according to an attribute of a neighborhood region of the first text; a supplementing module configured to supplement, if a first action item of action items included in the menu is selected by a user, the neighborhood region of the first text according to the first action item and to generate a supplemented neighborhood region; and a processor configured to perform an action corresponding to the first action item according to the supplemented neighborhood region.

### CROSS-REFERENCE TO RELATED APPLICATION(S)

This application claims priority from Japanese Patent Application No. 2012-125470 filed on May 31, 2012; the entire contents of which are incorporated herein by reference.

### FIELD

Embodiments described herein relate generally to an electronic apparatus, a control method of an electronic apparatus, and a control program of an electronic apparatus.

### BACKGROUND

In recent years, electronic apparatus such as tablet PCs and smartphones which enable a search using a keyword or the like that is specified by a user have come into wide use. In such electronic apparatus, a good search result can be obtained if a keyword or the like is specified precisely by means of a displayed cursor or the like.

In recent years, electronic apparatus which allow users to specify a keyword or the like by, for example, tracing across the display screen with a pen or a finger have also come into wide use. However, there is a problem that it is difficult to specify a keyword or the like using a pen or a finger and hence to obtain a good search result. It is therefore desired to make it possible to obtain a better search result in an electronic apparatus which allows a user to specify a keyword or the like by tracing across its display screen.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 shows an appearance of an electronic apparatus (tablet PC) according to an embodiment.

FIG. 2 shows an example configuration of the tablet PC.

FIG. 3 shows a specific operation of the tablet PC.

FIGS. 4A and 4B show a functional configuration of the tablet PC and a table of example attribute judgment rules, respectively.

FIG. 5 shows an operation of the tablet PC.

### DETAILED DESCRIPTION

One embodiment provides an electronic apparatus including: an output module configured to detect a first text from texts displayed on a display according to an operation by a user, and to output a menu according to an attribute of a neighborhood region of the first text; a supplementing module configured to supplement, if a first action item of action items included in the menu is selected by a user, the neighborhood region of the first text according to the first action item and to generate a supplemented neighborhood region; and a processor configured to perform an action corresponding to the first action item according to the supplemented neighborhood region.

An embodiment will be hereinafter described with reference to the drawings.

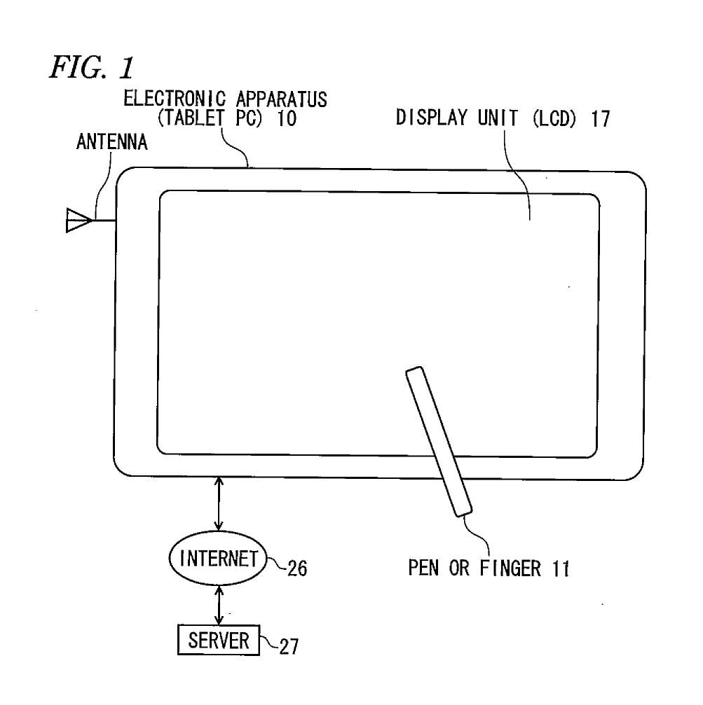

FIG. 1 shows an appearance of a tablet PC 10 which is an electronic apparatus according to the embodiment. In this embodiment, the tablet PC 10 detects a keyword traced by the user with a pen or finger 11 from a text that is displayed on a display unit 17, for example, and outputs a menu based on attributes of the information in a supplement candidate region which consists of the keyword and its neighborhood.

When one item of the menu is selected, the tablet PC 10 supplements the keyword according to the selected item and does the selected action using the supplemented keyword.

Although the embodiment is directed to the tablet PC 10 as an example electronic apparatus, the invention is not limited to such a case and the concept of the embodiment can also be applied to other kinds of electronic apparatus such as a notebook PC, a smartphone, a cell phone, portable and stationary TV receivers.

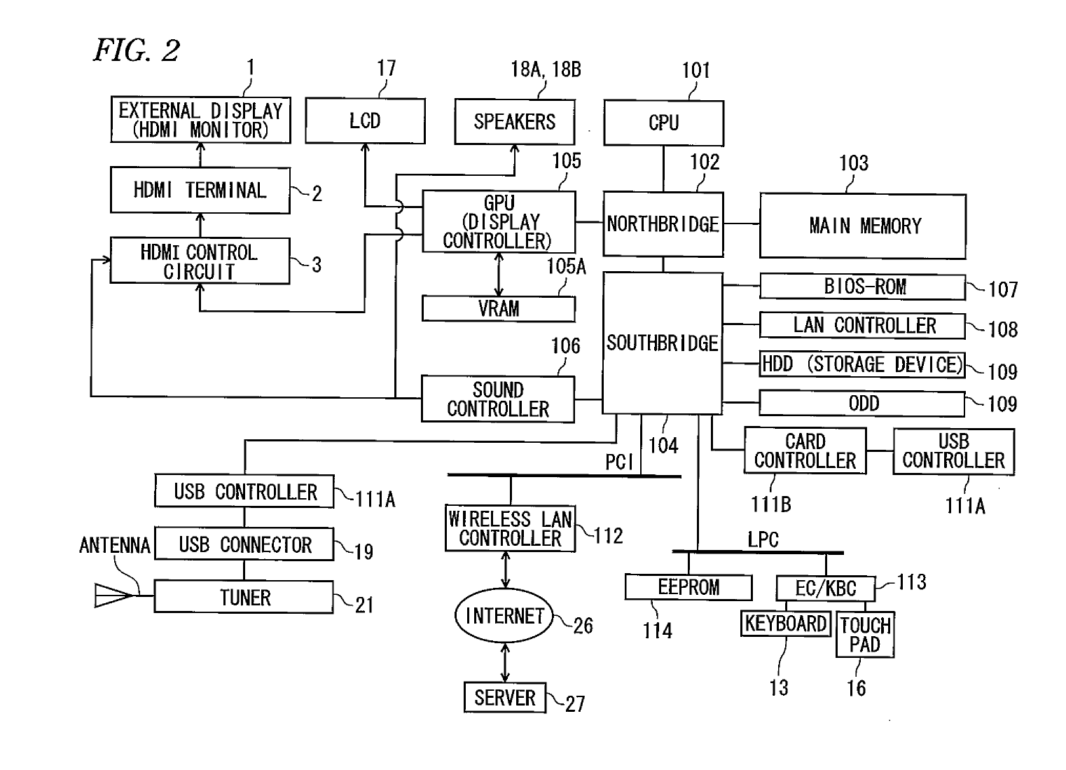

FIG. 2 shows an example configuration of the tablet PC 10. The tablet PC 10 is equipped with a CPU (central processing unit) 101, a northbridge 102, a main memory 103, a southbridge 104, a GPU (graphics processing unit) 105, a VRAM (video random access memory) 105A, a sound controller 106, a BIOS-ROM (basic input/output system-read only memory) 107, a LAN (local area network) controller 108, a hard disk drive (HDD; storage device) 109, an optical disc drive (ODD) 110, a USB controller 111A, a card controller 111 B, a wireless LAN controller 112, an embedded controller/keyboard controller (ECIKBC) 113, an EEPROM (electrically erasable programmable ROM) 114, etc.

The CPU 101 is a processor which controls operations of individual components of the tablet PC 10. The CPU 101 runs a BIOS which is stored in the BIOS-ROM 107. The BIOS is programs for hardware control.

The northbridge 102 is a bridge device which connects a local bus of the CPU 101 to the southbridge 104. The northbridge 102 incorporates a memory controller for access-controlling the main memory 103. The northbridge 102 also has a function of performing a communication with the GPU 105 via, for example, a serial bus that complies with the PCI Express standard.

The GPU 105 is a display controller which controls the display unit (LCD) 17 which is used as a display monitor of the tablet PC 10. A display signal generated by the GPU 105 is sent to the display unit (LCD) 17. The GPU 105 can also send a digital video signal to an external display 1 via an HDMI control circuit 3 and an HDMI terminal 2.

The HDMI terminal 2 is an external display connection terminal. The HDMI terminal 2 can send a non-compressed digital video signal and digital audio signal to the external display 1 such as a TV receiver via a single cable. The HDMI control circuit 3 is an interface for sending a digital video signal to the external display 1 (called an HDMI monitor) via the HDMI terminal 2.

The southbridge 104 controls individual devices on a PCI (peripheral component interconnect) bus and individual devices on an LPC (low pin count) bus. The southbridge 104 incorporates an IDE (integrated drive electronics) controller for controlling the HDD 109 and the ODD 110. The southbridge 104 also has a function of performing a communication with the sound controller 106.

The sound controller 106, which is a sound source device, outputs reproduction subject audio data to speakers 18A and 18B or the HDMI control circuit 3. The LAN controller 108 is a wired communication device which performs a wired communication according to the IEEE 802.3 standard, for example. On the other hand, the wireless LAN controller 112 is a wireless communication device which performs a wireless communication according to the IEEE 802.11g standard, for example.

The USB controller 111A performs a communication with an external device (connected to it via a USB connector) which complies with the USB 2.0 standard, for example. For example, the USB controller 111A is used for receiving an image data file from a digital camera. The card controller 111B writes and reads data to and from a memory card such as an SD card that is inserted in a card slot 111C that is formed in a computer main body of the tablet PC 10.

The EC/KBC 113 is a one-chip microcomputer in which an embedded controller for power management and a keyboard controller for controlling the keyboard 13 and the touch pad 16 are integrated together. The EC/KBC 113 has a function of powering on/off the tablet PC 10 in response to a user manipulation of a power button.

In the embodiment, a display control is performed in such a manner that, for example, the CPU 101 runs programs stored in the main memory 103, the HDD 109, etc. The above configuration of the tablet PC 10 is just an example, and the tablet PC 10 may have hardware whose configuration is different from the above-described one.

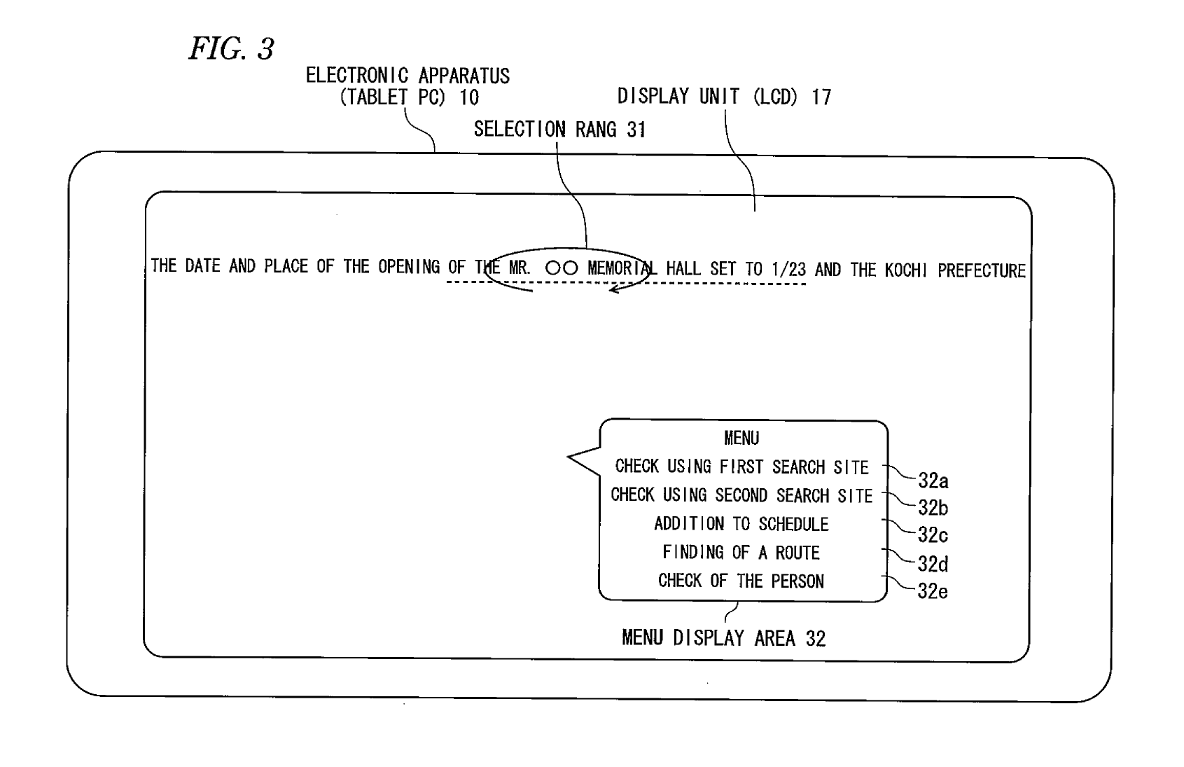

FIG. 3 shows a specific operation of the tablet PC 10. As described above, in the embodiment, the tablet PC 10 detects a keyword traced by the user with a pen or finger 11 from a text that is displayed on the display unit 17, for example.

In this example, as shown in FIG. 3, a text “The date and place of the opening of the Mr. ∘∘ Memorial Hall set to 1/23 and the Kochi prefecture” is displayed, and a part “the Mr. ∘∘ Memorial” (selection range 31) has been specified therein by the user's tracing manipulation on the display unit 17 with a pen or finger 11.

It is difficult for the user to precisely specify a keyword by a tracing manipulation using the pen or finger 11. For example, the user may have intended to select “the Mr. ∘∘ Memorial Hall” or “Mr. ∘∘.”

In view of the above, in the embodiment, even if it is unclear what range the user intended to specify, a range the user intended to specify is inferred based on an action that should be done using the words (“the Mr. ∘∘ Memorial”) in the selection range 31 and the information in the selection range 31 is thereby supplemented.

Furthermore, even if it is unclear what range the user intended to specify, a menu is presented by also using words existing in the neighborhood of the selection range 31. More specifically, a menu is output based on attributes of the information in a supplement candidate region which consists of the keyword and its neighborhood.

For example, as shown in FIG. 3, the menu is displayed in a menu display area 32. In this example, “check using the first search site” 32a, “check using the second search site” 32b, “addition to schedule” 32c, “finding of a route” 32d, and “check of the person” 32e axe displayed in the menu display area 32 as action items.

If one item of the displayed menu is selected by the user, the information in the selection range 31 is supplemented according to the selected item and the selected action is done using the supplemented information in the selection range 31.

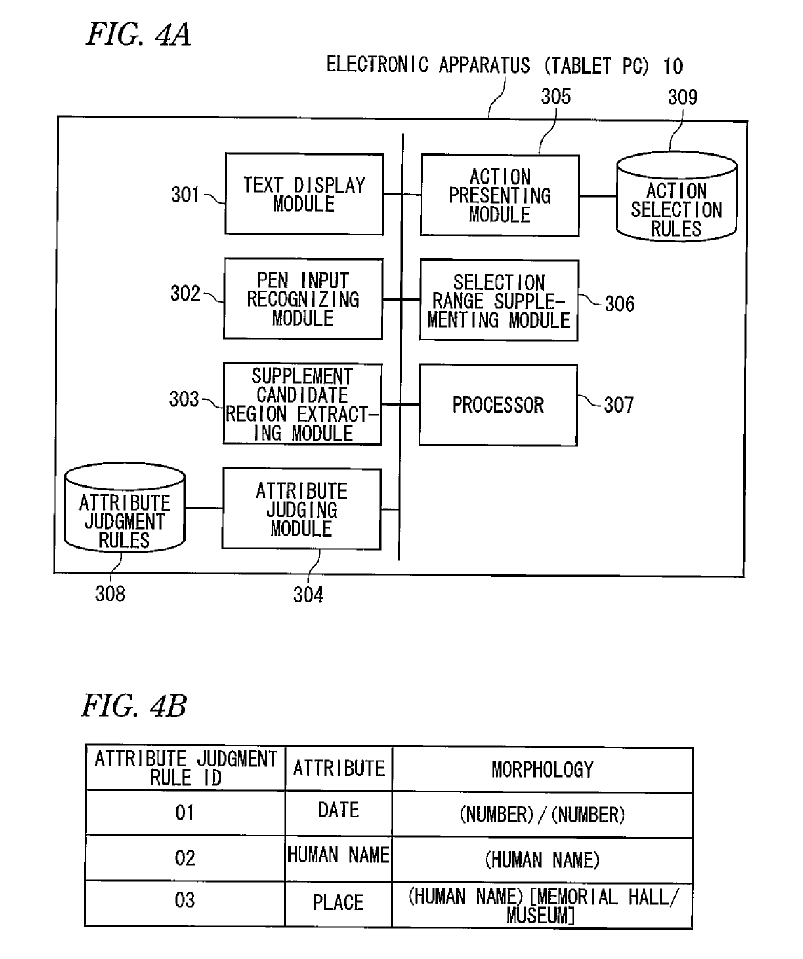

FIG. 4A shows a functional configuration of the tablet PC 10. In the embodiment, the tablet PC 10 is equipped with a text display module 301 for displaying a text (in FIG. 3, “The date and place of the opening of the Mr. ∘∘ Memorial Hall set to 1/23 and the Kochi prefecture”), a pen input recognizing module 302 for recognizing information that has been input by the user using a pen or finger 11, a supplement candidate region extracting module 303 for extracting the words in a supplement candidate region that consists of the selection range 31 of the input with the pen or finger 11 and its neighborhood (in FIG. 3, “of the opening of the Mr. ∘∘ Memorial Hall set to 1/23”), and an attribute judging module 304 for judging attributes of the words (in FIG. 3, “of the opening of the Mr. ∘∘ Memorial Hall set to 1/23”) extracted by the supplement candidate region extracting module 303.

The tablet PC 10 is also equipped with an action presenting module 305 for displaying (or presenting) a menu (see FIG. 3), a selection range supplementing module 306 for supplementing the information in the selection range 31, and a processor 307 for doing a selected action using supplemented information in the selection range 31.

The tablet PC 10 is also equipped with an attribute judgment rules storage unit 308 which is stored, in advance, with attribute judgment rules to be used by the attribute judging module 304 and an action selection rules storage unit 309 which is stored, in advance, with action selection rules to be used by the action presenting module 305.

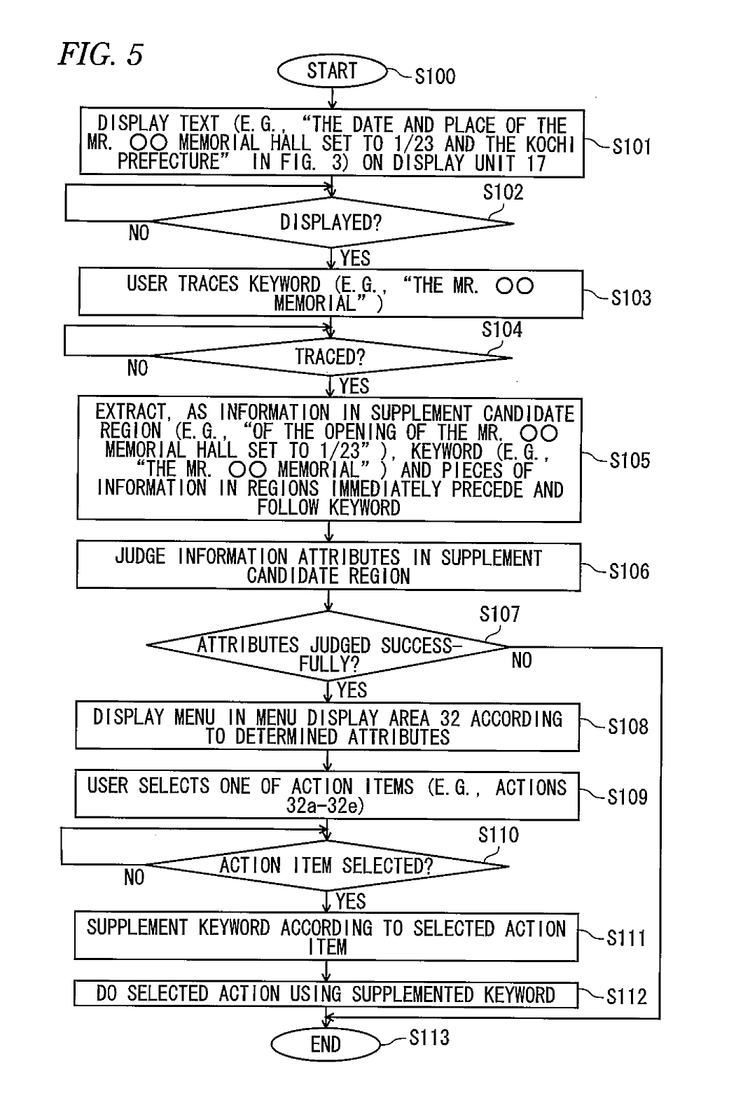

FIG. 5 shows an operation of the tablet PC 10.

The process starts at step S100. At step S101, a text is displayed on the display unit 17, for example, in response to a user manipulation (not shown). In the example of FIG. 3, the text “The date and place of the opening of the Mr. ∘∘ Memorial Hall set to 1/23 and the Kochi prefecture” is displayed.

The text that is displayed on the display unit 17 may be a web page or a hand-written note. In the case of a hand-written note, for convenience of processing to be performed subsequently, it may be a version as converted by hand-written character recognition so as to be suitable for language processing.

At step S102, it is judged whether or not the text has been displayed on the display unit 17. If it is judged that text has been displayed on the display unit 17 (S102: yes), the process moves to step S103. If not (S102: no), step S102 is executed again.

At step S103, the user traces a keyword that is displayed on the display unit 17. In the example of FIG. 3, “the Mr. ∘∘ Memorial” is traced. The user traces a portion relating to an intended action with a pen, for example.

In the embodiment, the term “to trace” means a manipulation (operation) for specifying a selection range 31 by, for example, surrounding a region of delimitation-intended characters (keyword) by a circle or a rectangle or drawing a wavy line under a region of delimitation-intended characters (keyword).

In general, in devices such as the tablet PC 10 in which input is made by hand using a pen, for example, it is difficult to specify the start and the end of an intended range precisely. Therefore, the user is caused to specify a range roughly. Assume here that a region roughly corresponding to “the Mr. ∘∘ Memorial” has been surrounded by a circle.

At step S104, it is judged whether or not a keyword has been traced by the user. If it is judged that a keyword has been traced (S104: yes), the process moves to step S105. If not (S104: no), step S104 is executed again.

At step S105, the information in a supplement candidate region which consists of the keyword “the Mr. ∘∘ Memorial” traced by the user and its neighborhood is extracted. In the example of FIG. 3, “of the opening of the Mr. ∘∘ Memorial Hall set to 1/23” is extracted. For example, the supplement candidate region extracting module 303 extracts, as information in a supplement candidate region, the keyword (selection range 31) plus pieces of information in prescribed regions that immediately precede and follow the keyword.

At step S106, attributes of the information in the supplement candidate region are judged. For example, the attribute judging module 304 checks attributes of words included in the supplement candidate region according to the attribute judgment rules.

FIG. 4B shows a table of example attribute judgment rules. Attributes can be given according to this table. For example, attribute judgment rules are expressed as “date: (number)/(number),” “human name: (human name),” and “place: (human name)[memorial hall/ museum].” For example, numbers, a human name, etc. are detected from the supplement candidate region by a morphological analysis and attributes are given according to the attribute judgment rules.

For example, as seen from FIG. 4B, “the Mr. ∘∘ Memorial” is given an attribute “place” according to the attribute judgment rule having an ID “03.”

At step S107, it is judged whether or not attributes have been judged successfully. If it is judged that attributes have been judged successfully (S107: yes), the process moves to step S108. If not (S107: no), the process moves to step S113.

At step S108, a menu is displayed in a menu display area 32 according to the determined attributes. The action presenting module 305 displays action items that are suitable for the attributes according to the action selection rules by referring to a menu dictionary, for example.

For example, the action selection rules are as follows. For the attribute “date,” an action item “addition to schedule” is displayed. For the attribute “human name,” action items “check using the first search engine (search site),” “check using the second search engine (search site),” and “check of the person” are displayed. For the attribute “place,” action items “display of a map,” “check using the first search engine (search site),” “check using the second search engine (search site),” and “check of a route” are displayed.

At step S109, one of the displayed action items (in FIG. 3, the action items 32a-32e) is selected by the user. At step S110, it is judged whether or not one of the displayed action items has been selected. If it is judged that one of the displayed action items has been selected (S110: yes), the process moves to step S111. If not (S110: no), step S110 is executed again.

At step S111, the information in the selection range 31 is supplemented according to the selected action item. The selection range supplementing module 306 supplements the information in the selection range 31 by finally determining the attribute and determining the words the user intended to specify.

For example, if the user selects the action item “check of a route” 32d, the selection range supplementing module 306 finally determines that the attribute is “place” and determines that the words the user intended to specify are “the Mr. ∘∘ Memorial Hall.”

If the action item “check using the first search site” 32a is selected, the selection range supplementing module 306 decides on both of the attributes “human name” and “place.” Therefore, the action presenting module 305 displays a further detailed action menu, that is, presents action items “check of Mr. ∘∘ using the first search site” and “check of the Mr. ∘∘ Memorial Hall using the first search site” which correspond to the attribute “human name.”

At step S112, the selected action is done using the supplemented information in the selection range 31. Words are set for the selected action using the above-determined words.

For example, if the user selects the action item “check of a route” 32d, the processor 307 understands that the user wants to check a route to “the Mr. ∘∘ Memorial Hall” and sets “the Mr. ∘∘ Memorial Half” as a destination in an application for checking a route and makes a search.

To check a route, the processor 307 may input words that have been determined as a destination in a web train change guide service, make a search, and inform the user of a search result. To check a person, the processor 307 may input words that have been determined as a human name in a web search site, make a search, and inform the user of a search result. The process is finished at step S113.

Alternatively, instead of presenting a menu by the action presenting module 305, the tablet PC 10 may be configured so as to allow the user to input an action verbally. In this case, the system is equipped with a speech recognition module. If the user utters “a route” after making a tracing manipulation, the information in the selection range 31 is supplemented so as to become “the Mr. ∘∘ Memorial Hall.”

As described above, according to the embodiments, a keyword (e.g., “the Mr. ∘∘ Memorial”) that has been traced by a user in a text (e.g., “The date and place of the opening of the Mr. ∘∘ Memorial Hall set to 1/23 and the Kochi prefecture”) that is displayed on the display unit 17, for example, is detected, and a menu is output according to information attributes in a supplement candidate region which consists of a region of the keyword and its neighborhood. When one action item of the menu is selected by the user, the keyword is supplemented according to the selected action item. The selected action is done using the supplemented keyword.

The information attributes in the supplement candidate region are judged according to the preset attribute judgment rules.

The information in the supplement candidate region includes text portions that are adjacent to the keyword traced by the user.

The keyword is supplemented using a word or words contained in the neighborhood of the keyword.

The electronic apparatus is configured so as to allow a user to trace a keyword with a pen or a finger.

The menu contains plural action items (e.g., actions 32a-32e).

Configured as described above, the embodiments make it possible to obtain a better search result in an electronic apparatus which allows a user to specify a keyword or the like by tracing across its display screen.

All the steps of the control process according to each embodiment can be implemented by software. Therefore, the advantages of each embodiment can easily be obtained merely by installing programs of the control process in an ordinary computer via a computer-readable storage medium that is stored with those programs and running the installed programs.

The invention is not limited to the above embodiments themselves and, in the practice stage, may be embodied in such a manner that constituent elements are modified in various manners without departing from the spirit and scope of the invention. And various inventive concepts may be conceived by properly combining plural constituent elements disclosed in each embodiment. For example, several ones of the constituent elements of each embodiment may be omitted. Furthermore, constituent elements of the different embodiments may be combined as appropriate.

1. An electronic apparatus comprising:
an output module configured to detect a first text from texts displayed on a display according to an operation by a user, and to output a menu according to an attribute of a neighborhood region of the first text;
a supplementing module configured to supplement, if a first action item of action items included in the menu is selected by a user, the neighborhood region of the first text according to the first action item and to generate a supplemented neighborhood region; and
a processor configured to perform an action corresponding to the first action item according to the supplemented neighborhood region.

2. The apparatus of claim 1,
wherein the attribute of the neighborhood region is judged according to preset attribute rules.

3. The apparatus of claim 1,
wherein the supplemented neighborhood region comprises texts adjacent to the first text.

4. The apparatus of claim 1,
wherein the supplementing module is further configured to supplement the supplemented neighborhood region using texts included in the neighborhood region.

5. The apparatus of claim 1,
wherein the operation of the user is a tracing manipulation.

6. A control method of an electronic apparatus, the method comprising:
receiving a tracing manipulation by a user on texts displayed on a display;
detecting a first text from the texts according to the tracing manipulation;
defining a supplement candidate region comprising a region of the first text and its neighborhood region;
outputting a menu according to an attribute of the neighborhood region;
if a first action item of action items included in the menu is selected by the user, supplementing the neighborhood region according to the first action item to generate a supplemented neighborhood region; and
performing an action corresponding to the first action item according to the supplemented neighborhood region.

7. A control program for controlling an electronic apparatus, the control program causing the electronic apparatus to execute a process, the process comprising:
receiving a tracing manipulation by a user on texts displayed on a display;
detecting a first text from the texts according to the tracing manipulation;
defining a supplement candidate region comprising a region of the first text and its neighborhood region;
outputting a menu according to an attribute of the neighborhood region;
if a first action item of action items included in the menu is selected by the user, supplementing the neighborhood region according to the first action item to generate a supplemented neighborhood region; and
performing an action corresponding to the first action item according to the supplemented neighborhood region.
